(19) United States
(12) Patent Application Publication
(10) Pub. No.: US 2024/0313923 A1
(43) Pub. Date: Sep. 19, 2024

(54) CONTROL CHANNEL BASED ROUTING FOR MULTIPLE RELAY BASED COMMUNICATION

(71) Applicant: QUALCOMM INCORPORATED, San Diego, CA (US)

(72) Inventors: Luanxia YANG, Beijing (CN); Jing SUN, San Diego, CA (US); Changlong XU, Beijing (CN); Xiaoxia ZHANG, San Diego, CA (US); Rajat PRAKASH, San Diego, CA (US); Hao XU, Beijing (CN); Shaozhen GUO, Beijing (CN); Siyi CHEN, Beijing (CN)

(21) Appl. No.: 18/263,654

(22) PCT Filed: Apr. 3, 2021
(86) PCT No.: PCT/CN2021/085498

§ 371 Date: Jul. 31, 2023

(51) Int. Cl. H04L 5/00; H04W 72/232

(52) U.S. Cl. CPC H04L 5/0053; H04W 72/232

(57) ABSTRACT

Various aspects of the present disclosure generally relate to wireless communication. In some aspects, a node may receive a first control channel associated with a multiple relay based communication. The node may identify a target node of a pay load of the first control channel based at least in part on at least one of: information included in the payload, or an identifier associated with the first control channel. The node may transmit a second control channel carrying the pay load toward the target node if the node is not the target node. The node may decode the payload, if the node is the target node. Numerous other aspects are described.

### FIELD OF THE DISCLOSURE

Aspects of the present disclosure generally relate to wireless communication and to techniques and apparatuses for control channel based routing for multiple relay based communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a node includes receiving a first control channel associated with a multiple relay based communication; identifying a target node of a payload of the first control channel based at least in part on at least one of: information included in the payload, or an identifier associated with the first control channel; and transmitting a second control channel carrying the payload toward the target node if the node is not the target node; or decoding the payload, if the node is the target node.

In some aspects, a method of wireless communication performed by a base station includes generating a multiple relay based communication including a first control channel with a payload destined for a user equipment (UE); and transmitting, to a node, the first control channel, wherein the first control channel indicates a target node of a payload of the first control channel based at least in part on at least one of: information included in the payload, or an identifier associated with the first control channel.

In some aspects, a node includes one or more memories; and one or more processors, coupled to the one or more memories, configured to: receive a first control channel associated with a multiple relay based communication; identify a target node of a payload of the first control channel based at least in part on at least one of: information included in the payload, or an identifier associated with the first control channel; and transmit a second control channel carrying the payload toward the target node if the node is not the target node; or decode the payload, if the node is the target node.

In some aspects, a base station includes one or more memories; and one or more processors, coupled to the one or more memories, configured to: generate a multiple relay based communication including a first control channel with a payload destined for a UE; and transmit, to a node, the first control channel, wherein the first control channel indicates a target node of a payload of the first control channel based at least in part on at least one of: information included in the payload, or an identifier associated with the first control channel.

In some aspects, a non-transitory computer-readable medium storing a set of instructions includes one or more instructions that, when executed by one or more processors of a node, cause the node to: receive a first control channel associated with a multiple relay based communication; identify a target node of a payload of the first control channel based at least in part on at least one of: information included in the payload, or an identifier associated with the first control channel; and transmit a second control channel carrying the payload toward the target node if the node is not the target node; or decode the payload, if the node is the target node.

In some aspects, a non-transitory computer-readable medium storing a set of instructions includes one or more instructions that, when executed by one or more processors of a base station, cause the base station to: generate a multiple relay based communication including a first control channel with a payload destined for a UE; and transmit, to a node, the first control channel, wherein the first control channel indicates a target node of a payload of the first control channel based at least in part on at least one of: information included in the payload, or an identifier associated with the first control channel.

In some aspects, an apparatus includes means for receiving a first control channel associated with a multiple relay based communication; means for identifying a target node of a payload of the first control channel based at least in part on at least one of: information included in the payload, or an identifier associated with the first control channel; and means for transmitting a second control channel carrying the payload toward the target node if the apparatus is not the target node; or means for decoding the payload, if the node is the target node.

In some aspects, an apparatus includes means for generating a multiple relay based communication including a first control channel with a payload destined for a UE; and means for transmitting, to a node, the first control channel, wherein the first control channel indicates a target node of a payload of the first control channel based at least in part on at least one of: information included in the payload, or an identifier associated with the first control channel.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of multiple relay based communication, in accordance with the present disclosure.

FIGS. 4-7B are diagrams illustrating examples associated with control channel based routing for multiple relay based communication, in accordance with the present disclosure.

FIGS. 8 and 9 are diagrams illustrating example processes associated with control channel based routing for multiple relay based communication, in accordance with the present disclosure.

FIGS. 10 and 11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

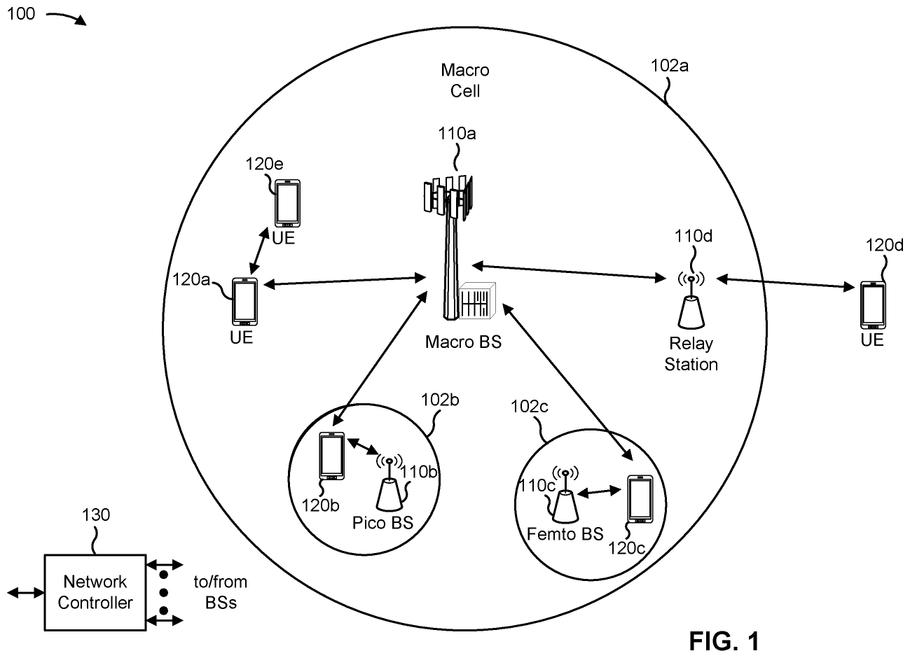

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations, such as relay station 110d. A relay station 110d is an entity that can receive a transmission of data from an upstream station (e.g., a BS or a UE) and send a transmission of the data to a downstream station (e.g., a UE or a BS). A relay station 110d may also be a UE that can relay transmissions for other UEs. In the example shown in FIG. 1, a relay station 110d may communicate with macro BS 110a and a UE 120d in order to facilitate communication between BS 110a and UE 120d. A relay station 110d may also be referred to as a node, a relay node, a relay BS, a relay base station, a relay UE, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

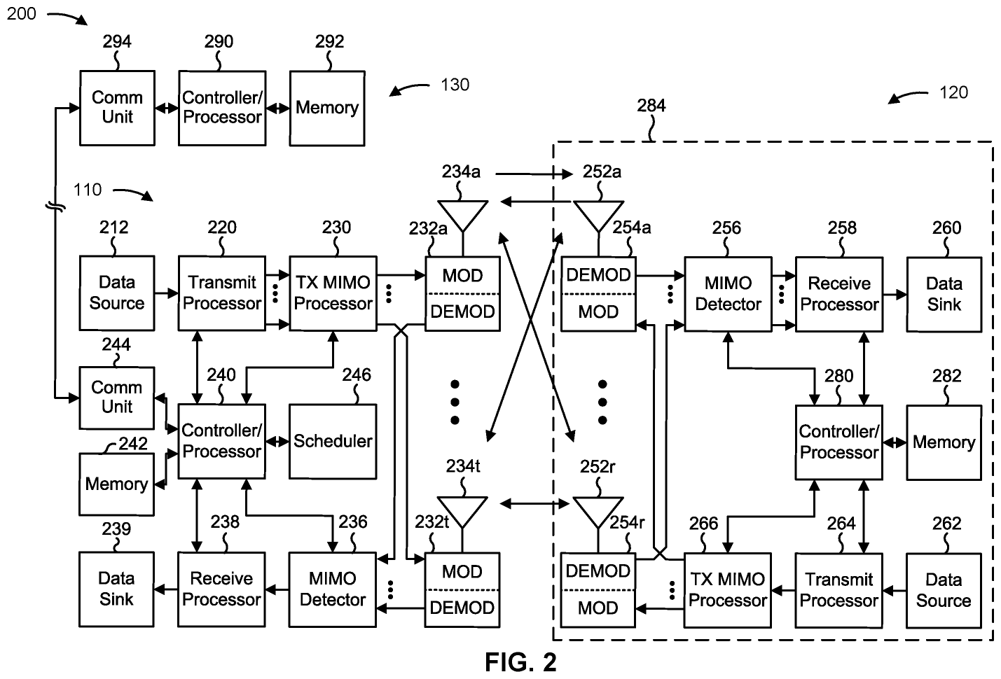

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

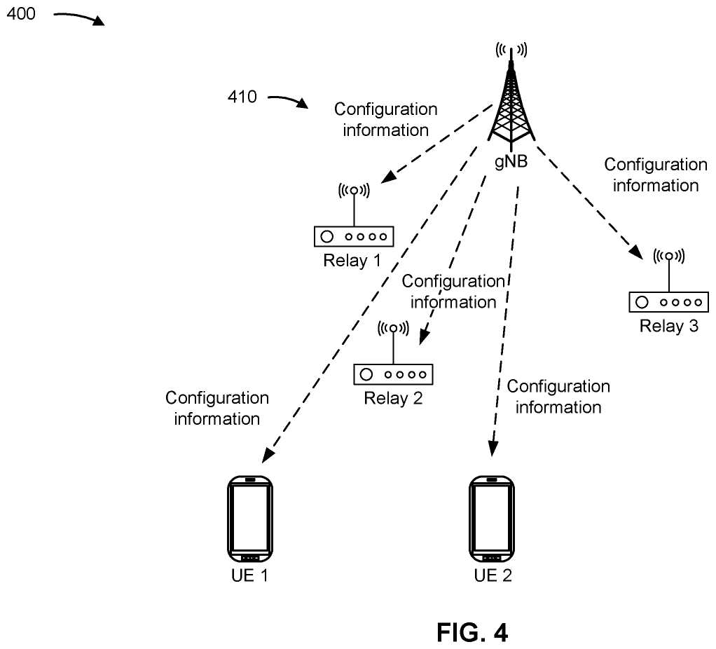

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-9).

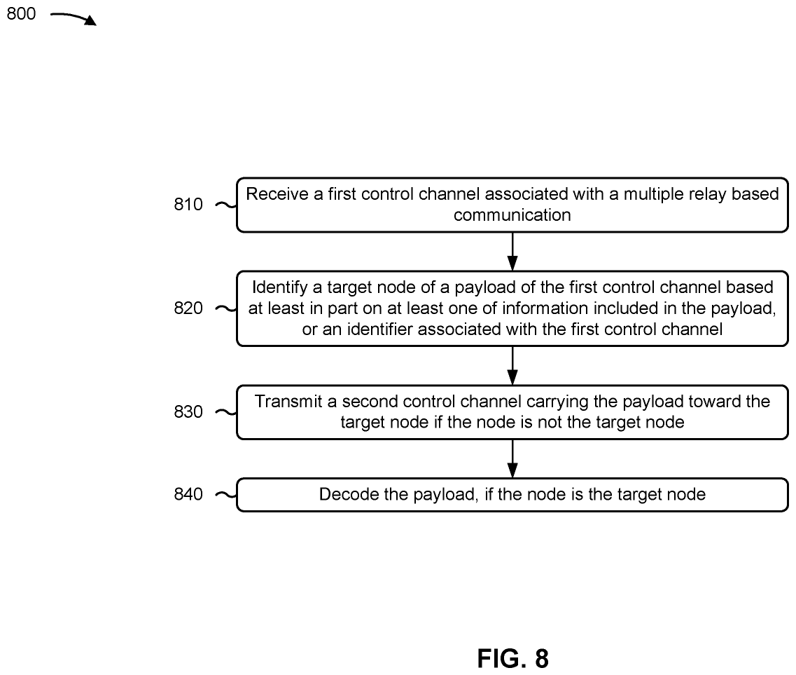

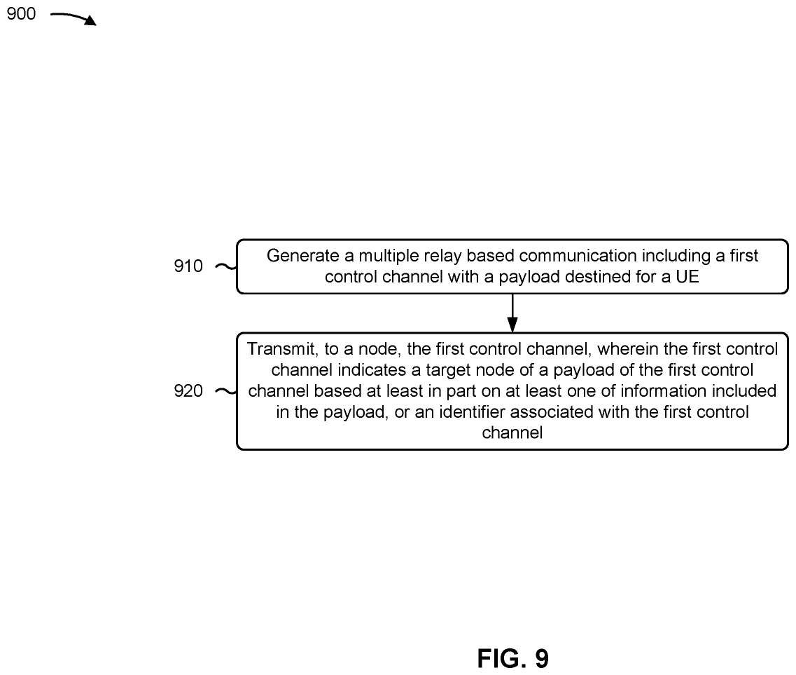

Controller/processor 240 of base station 110, controller/processor 280 of UE 120, and/or any other component(s) of FIG. 2 may perform one or more techniques associated with control channel based routing for multiple relay based communication, as described in more detail elsewhere herein. In some aspects, the node described herein (e.g., also referred to as relay station 110d, relay node, relay BS, and/or relay UE) is the base station 110, is included in the base station 110, or includes one or more components of the base station 110 shown in FIG. 2. In some aspects, the node described herein is the UE 120, is included in the UE 120, or includes one or more components of the UE 120 shown in FIG. 2. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the node includes means for receiving a first control channel associated with a multiple relay based communication; means for identifying a target node of a payload of the first control channel based at least in part on at least one of: information included in the payload, or an identifier associated with the first control channel; or means for transmitting a second control channel carrying the payload toward the target node if the node is not the target node; or means for decoding the payload, if the node is the target node. In some aspects, the means for the node to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the node to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station includes means for generating a multiple relay based communication including a first control channel with a payload destined for a UE; and/or means for transmitting, to a node, the first control channel, wherein the first control channel indicates a target node of a payload of the first control channel based at least in part on at least one of: information included in the payload, or an identifier associated with the first control channel. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

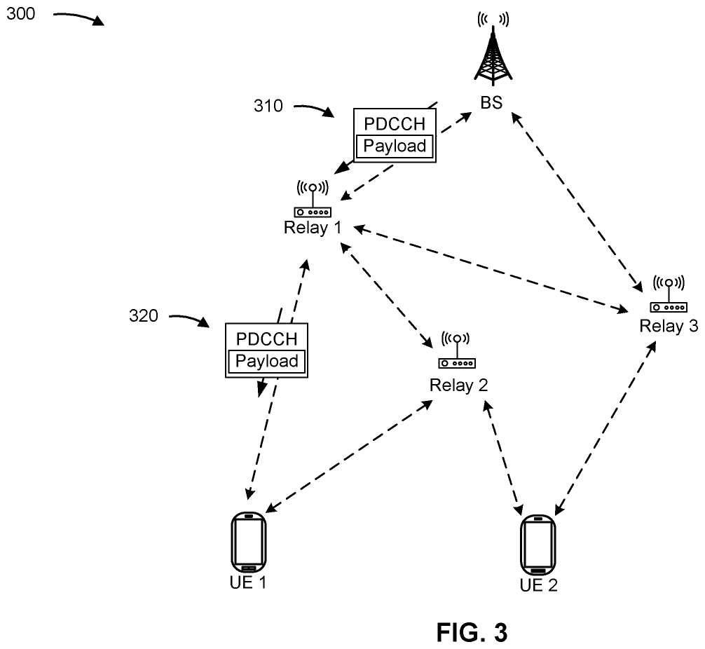

FIG. 3 is a diagram illustrating an example 300 of multiple relay based communication, in accordance with the present disclosure.

As shown in FIG. 3, a base station may communicate with UEs via relays. For example, there may be multiple links (depicted by dotted lines) between the base station, relays, and UEs. Communications (e.g., data and/or control information) between the base station and a UE may be transmitted via one or more of the relays. For example, as shown by reference number 310, the base station may transmit a communication (e.g., via a payload included in a physical layer downlink control channel (PDCCH)) to Relay 1. As shown by reference number 320, Relay 1 may relay (e.g., forward or transmit) the communication to UE 1. The sequence of hops followed by the PDCCH (in example 300, BS to Relay 1 to UE 1) is referred to herein as a path or a link. In some contexts, “path” or “link” may indicate only hops between a BS and a relay. In other contexts, “path” or “link” indicates hops between a BS and a relay and between a relay and a UE.

The base station may control the transmission and retransmission of each relay and the content to be transmitted. To ensure the communications are forwarded, the base station may track the status of decoding payloads (e.g., transport blocks) at each relay. In a situation where a payload is decoded at a relay, the payload can be forwarded down-stream (e.g., to the destination UE). In a situation where a relay fails to decode a payload, the base station may schedule retransmission of the payload to the relay.

Using a relay (e.g., as shown in FIG. 3) may improve network performance and increase reliability by providing link diversity for communications between a UE and base station. For example, the relays may be used to increase the coverage of the base station and also reduce the load of the base station. Furthermore, link diversity enables graceful handling of a failed link, such as due to a blockage associated with a beamformed communication.

While the use of a relay to relay communications between a base station and UE may improve network performance, traditionally, a direct communication between the relay and the base station is required to enable the base station to schedule the relay's downlink and uplink communications. This limits the use of relays to a single relay between the base station and the UE.

As indicated above, FIG. 3 is provided as an example. Other examples may differ from what is described with respect to FIG. 3.

In some aspects described herein, a base station may generate a multiple relay based communication including a first control channel (e.g., a first PDCCH) with a payload destined for a UE. The first control channel may indicate a target node (e.g., a target relay node) of the payload based at least in part on information included in the payload (such as a UE identifier, a link identifier, one or more identifiers of relays, or the like), an identifier (e.g., a radio network temporary identifier (RNTI)) associated with the first control channel, or a combination thereof. The base station may transmit the first control channel to a node (e.g., a relay node). The node may receive the first control channel and identify a target node of the payload based at least in part on the information included in the payload, the identifier associated with the first control channel, or a combination thereof. The node may then transmit a second control channel (e.g., a second PDCCH) carrying the payload toward the target node, if the node is not the target node. If the node is the target node, the node may decode the payload.

In this way, some techniques and apparatuses described herein enable the use of multiple relays for communications between a base station and UE. This may improve network performance and increase reliability by providing link diversity for communications between a UE and base station. In addition, the use of multiple relays may increase an effective range and/or coverage of the base station, while also reducing the load of the base station. The use of control channel based routing may also conserve resources of the base station, including processing resources, time resources, memory resources, and/or power resources, among other examples, which may include resources that would otherwise be consumed by the base station to track the status of decoding at multiple nodes and/or schedule a node's downlink and uplink communications.

FIG. 4 is a diagram illustrating an example 400 associated with control channel based routing for multiple relay based communication, in accordance with the present disclosure. As shown in FIG. 4, a base station (e.g., base station 110) and multiple nodes (e.g., relay stations 110d, UE 120) may communicate with one another and with one or more UEs (e.g., UE 120).

As shown by reference number 410, the base station may transmit, and one or more nodes (e.g., relay 1, relay 2, and/or relay 3) and/or one or more UEs (e.g., UE 1 and/or UE 2) may receive, configuration information. In some aspects, a node and/or UE may receive the configuration information via one or more of radio resource control (RRC) signaling, MAC control elements (MAC CEs), downlink control information (DCI), a combination thereof, and/or the like. In some aspects, the configuration information may include an indication of one or more configuration parameters (e.g., already known to the node or UE) for selection by the node or UE, and/or explicit configuration information for the node or UE to use to configure the UE, among other examples. In some aspects, the configuration information may configure the node or UE, and/or enable the node or UE to configure itself, in a manner designed to enable control channel based routing for multiple relay based communication.

In some aspects, the configuration information may be associated with routing information. For example, the configuration information may configure (e.g., via RRC signaling) a mapping of one or more node identifiers (e.g., RNTI or a compressed form of identifier indicated by the configuration information) to a UE identifier (e.g., RNTI or a compressed form of identifier indicated by the configuration information) (e.g., in a situation where routing information for a PDCCH is to be included in a payload of the PDCCH).

In some aspects, the configuration information may indicate that a node is to pad a DCI payload of a PDCCH. For example, in a situation where a node receives a first PDCCH and is to generate a second PDCCH, the node may be configured to remove a destination identifier (e.g., a node identifier of the node) from the DCI payload of the first PDCCH and pad the DCI payload (such as using one or more filler bits) to a preconfigured length for transmission to a child node (e.g., a next target node) in the second PDCCH. Padding the DCI payload to the preconfigured length simplifies DCI processing for downstream nodes.

In some aspects, the configuration information may configure, for a node, node identifiers for each other node to which the node is connected. For example, in some situations, routing information for a PDCCH is carried in the payload of the PDCCH, and a link identifier (link ID) may be used in place of a node identifier (e.g., RNTI) to reduce the load of the PDCCH (each link ID identifying a route from the base station to each node). In such situations, the configuration information may preconfigure each node with RNTIs for each connected node, enabling the node to determine, using the link ID, which RNTI should be used to transmit the PDCCH to a next node. In some aspects, the configuration information indicates that the PDCCH is to include, in the link ID, the UE identifier (e.g., RNTI) of the destination UE. In this situation, the PDCCH would not need to include a separate UE identifier, as the UE identifier would be part of the link ID preconfigured for each route between the base station and the UE.

In some aspects, the configuration information may include information indicating a mapping between an identifier associated with a control channel and a child node of the node. A “child node” of a node is a node that is downstream from the node on a path. For example, if a communication is relayed from the BS, to Relay 1, then to Relay 2, Relay 2 is a child node of Relay 1. In some aspects, the mapping indicates an identifier for a control channel associated with routing the payload to the target node. For example, in a situation where an identifier (e.g., RNTI) is used to indicate routing information for a PDCCH, the base station may configure one or more nodes (e.g., via the configuration information) with a mapping from the identifier of an incoming PDCCH to the child node, and with the RNTI to be used for the outgoing PDCCH. In some aspects, the identifier for the control channel corresponds to a plurality of nodes, including a child node of the node, on a path to the target node. For example, an RNTI may correspond to multiple nodes, indicating a route to the target node and/or the destination UE. “Route” is synonymous with “path” as used herein.

By way of example, in FIG. 4, the configuration information may indicate eleven RNTIs for relay 1: a self RNTI (e.g., RIC-RNTI) and five pairs. The five pairs may include a pair for relay 2 (e.g., R12-RNTI for incoming PDCCH, R2C-RNTI for outgoing PDCCH), a pair for UE 1 through relay 2 (e.g., R121-RNTI for incoming PDCCH, R21C-RNTI for outgoing PDCCH), a pair for UE 2 through relay 2 (e.g., R122-RNTI for incoming PDCCH, R22C-RNTI for outgoing PDCCH), a pair for relay 3 (e.g., R13-RNTI for incoming PDCCH, R3C-RNTI for outgoing PDCCH), a pair for UE 2 though relay 3 (e.g., R132-RNTI for incoming PDCCH, R32C-RNTI for outgoing PDCCH). In this example, relay 2 and relay 3 may each have five RNTIs configured via the configuration information, UE 1 may have one RNTI configured via the configuration information, and UE 2 may have 3 RNTIs configured via the configuration information.

In some aspects, the configuration information may indicate that a node is to be configured with an identifier (e.g., RNTI) for each route associated with that node. For example, in some aspects, all nodes on a route share the same RNTI for that route. By way of example, in FIG. 4, the configuration information may indicate six RNTIs for relay 1: a first RNTI for the route from the base station to relay 1; a second RNTI for the route from the base station to relay 1, to relay 2; a third RNTI for the route from the base station to relay 1, to relay 2, and to UE 1; a fourth RNTI for the route from the base station to relay 1, to relay 2, and to UE 2; a fifth RNTI for the route from the base station to relay 1, to relay 3; and a sixth RNTI for the route from the base station to relay 1, to relay 3, to UE 2. In this example, three RNTIs may be configured for relay 2, four for relay 3, one for UE 1, and three for UE 2.

In some aspects, the configuration information may indicate that nodes monitoring the same node identifier (e.g., the same RNTI) are to be configured to avoid false detection. For example, nodes may be configured to use a different search space for transmission and reception of control information, time division multiplexing (TDM) for control information and/or payload transmission, and/or frequency division multiplexing (FDM) for control information and/or payload transmission, among other examples.

In some aspects, the configuration information may indicate that one or more of the nodes are to be configured for a first type of routing, and one or more other nodes are to be configured for a second type of routing. In some aspects, the identifier for a control channel corresponds to multiple nodes, including a child node of the node, on a path to a target node, and the identifier for the control channel is the same, irrespective of an upstream route of the control channel. For example, some nodes may be configured with a mapping of identifiers (e.g., RNTIs) of incoming PDCCH to a next node ID and the identifier (e.g., RNTI) to be used for an outgoing PDCCH. The nodes not configured in the foregoing manner may be configured using a shared identifier (e.g., a shared RNTI), such that an incoming PDCCH from different routes would share the same identifier. For example, the identifier for the control channel may be the same irrespective of an upstream route of the control channel.

By way of example, in FIG. 4, the configuration information for relay 1 may indicate that relay 1 is to use a first type of routing (e.g., routing based at least in part on RNTIs), such as mapping a RNTI of an incoming PDCCH to a next node, or mapping the RNTI of the incoming PDCCH to a shared RNTI for a route to the target node (e.g., the prior to the destination UE). The configuration information may further indicate that relay 1, when generating the outgoing PDCCH, is to use a second type of routing (e.g., routing based at least in part on PDCCH payload), such as providing the target node ID (e.g., target node RNTI) in the PDCCH payload, providing the UE ID (e.g., UE RNTI) with the target node ID in the PDCCH payload, or adding a link ID to the PDCCH payload. In this situation, for example, relay 1 may be configured with three RNTIs, one for itself, one for a route to relay 2, and one for a route to relay 3; two RNTIs may be configured for relay 2 (e.g., one RNTI for itself, and another for the route from relay 1); and three RNTIs may be configured for relay 3 (e.g., one RNTI for itself, another for the route from relay 1, and another for the route from the base station to itself).

In some aspects, the configuration information may indicate that a node is to receive a grant for a resource associated with a second control channel, and the second control channel may be transmitted on the resource of the grant. For example, when a node generates an outgoing PDCCH, for an uplink reception, the PDCCH may carry information for an uplink grant DCI from a parent node to a child node. In some aspects, the uplink grant is dynamic. In other aspects, the uplink grant is a configured grant (e.g., configured based at least in part on the configuration information).

As indicated above, FIG. 4 is provided as an example. Other examples may differ from what is described with regard to FIG. 4.

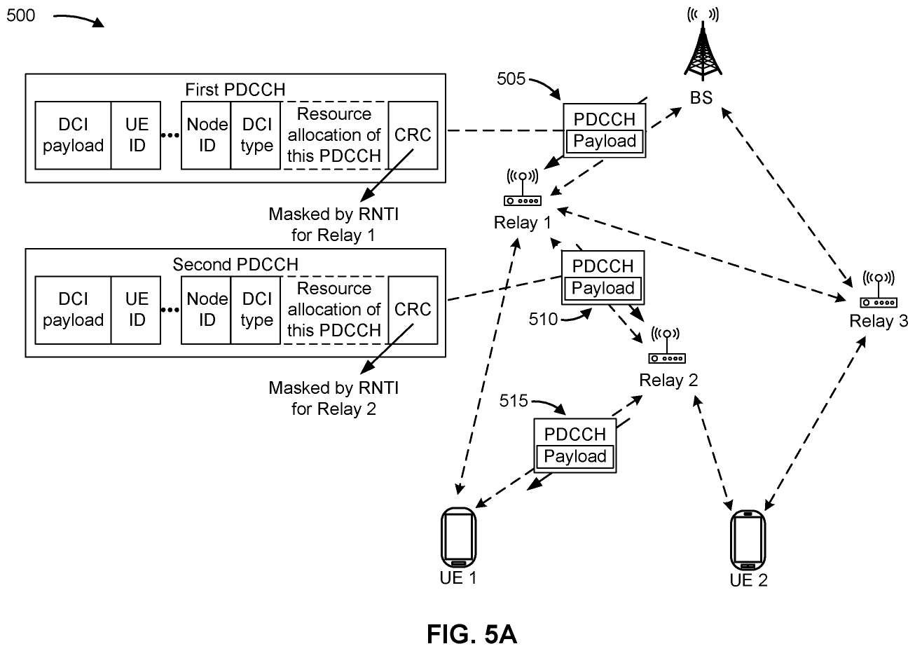

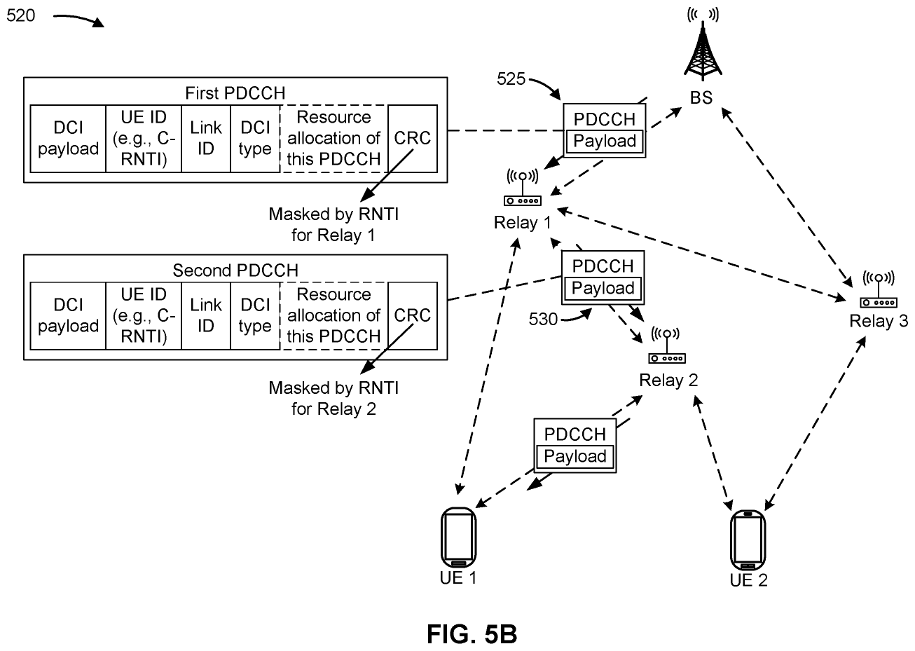

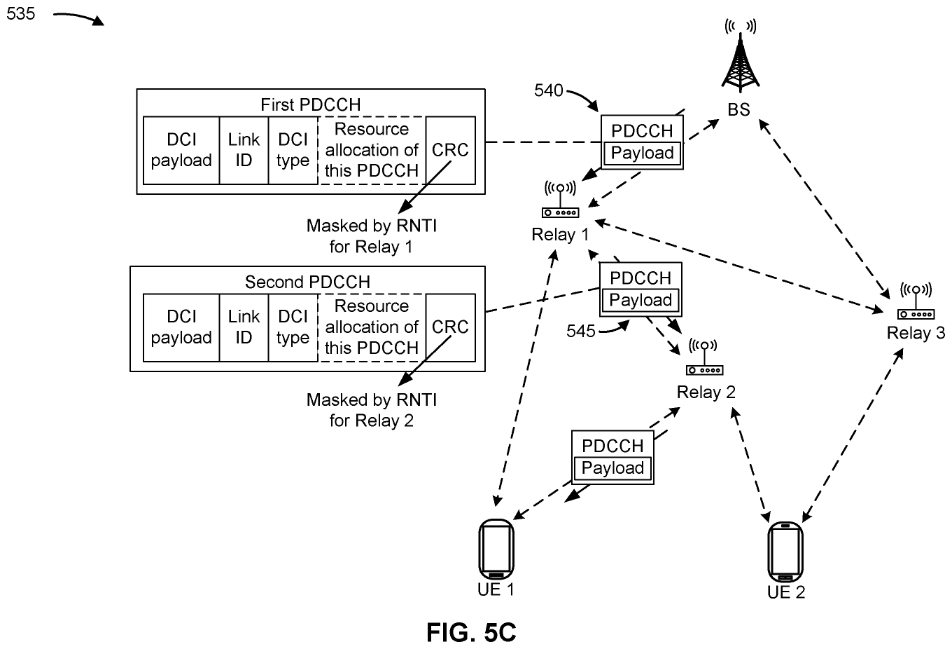

FIG. 5A is a diagram illustrating an example 500 associated with control channel based routing for multiple relay based communication, in accordance with the present disclosure. As shown in FIG. 5A, a base station (e.g., base station 110) and multiple nodes (e.g., relay stations 110d, UE 120) may communicate with one another and with one or more UEs (e.g., UE 120).

As shown by reference number 505, the base station may transmit, and the node (e.g., relay 1) may receive, a first control channel (e.g., PDCCH) associated with a multiple relay based communication. In some aspects, the information included in the payload includes a node identifier of one or more nodes on a path between a source of the payload and the target node. For example, the PDCCH depicted by reference number 505 includes data identifying UE ID (e.g., RNTI of UE 1) and at least one Node ID (e.g., RNTIs of nodes along the path from the base station to the target UE). As used herein, the target node may be a UE or a relay.

In some aspects, configuration information, provided by the base station, may indicate that the node identifier, included in the payload, is configured as associated with the path between the source of the payload and the target node or the one or more nodes. For example, the nodes on the path may be represented by individual node identifiers, such that three node identifiers may be included for each of three nodes along the path. Additionally, or alternatively, node IDs and/or UE IDs may be compressed in accordance with the configuration information, enabling the identifiers to be stored in the payload in a compressed format.

The node may identify a target node of a payload of the first control channel based at least in part on information included in the payload, and/or an identifier associated with the first control channel. In some aspects, the node may remove the node identifier from the payload for transmission of the payload via a second control channel (e.g., a second PDCCH). In this situation, the node may pad the payload (e.g., using zero-padding or another padding method) to satisfy a DCI length threshold. The node may further add, to the payload, an update node identifier for transmission via the second control channel. In some aspects, the node may remove a destination field, which includes the node identifier, from the payload for transmission via the second control channel, without padding the payload. In this situation, each node may need to be configured (e.g., via configuration information) to support varied DCI lengths.

As shown by reference number 510, the node may transmit a second control channel carrying the payload toward the target node if the node is not the target node. By way of example, the PDCCH generated by relay 1 for transmission to relay 2 may use different node IDs in the payload of the PDCCH (e.g., removing the RNTI of relay 1 from the payload), and the cyclic redundancy check portion of the PDCCH may be masked by the RNTI of the next node, relay 2.

Alternatively, if the node is the target node, the node may decode the payload. For example, as shown by reference number 515, relay 2 may be the target node. In this situation, when relay 2 receives the PDCCH from relay 1, relay 2 may decode and use the payload itself.

In some aspects, the base station may transmit, and the node may receive, a grant for a resource associated with the second control channel, and the second control channel may be transmitted on the resource of the grant. For example, for a downlink transmission, the PDCCH carries information regarding the downlink grant in a DCI. The node may transmit the downlink grant using information from the PDCCH. For an uplink reception, the PDCCH carries information for an uplink grant DCI from parent node to child node. The node may send an uplink grant using information from the PDCCH. In some aspects, the grant can be a dynamic grant. In some aspects, the grant can be a configured grant.

As indicated above, FIG. 5A is provided as an example. Other examples may differ from what is described with regard to FIG. 5A.

FIG. 5B is a diagram illustrating an example 520 associated with control channel based routing for multiple relay based communication, in accordance with the present disclosure. As shown in FIG. 5B, a base station (e.g., base station 110) and multiple nodes (e.g., relay stations 110d) may communicate with one another and with one or more UEs (e.g., UE 120). Some parts of example 520 shown in FIG. 5B are similar to example 500 of FIG. 5A. Therefore, the description of FIG. 5B focuses on some differences between examples 500 and 520 (though examples 500 and 520 may differ from each other in ways not explicitly described here).

As shown by reference number 525, in some aspects, the information included in the payload (e.g., of the first PDCCH) includes a UE identifier of a UE associated with the payload (e.g., an RNTI of the destination UE) and a link ID of a path between a source of the payload and the target node. For example, rather than including, in the control channel payload, separate node identifiers for each of the nodes along a path from the base station to the destination UE, a link ID may be used. The link ID identifies the route from the base station to the target relay and may reduce a load of the first control channel, relative to including multiple node identifiers in the payload. For example, each node's RNTI may take 16 bits to represent, and a single link ID (e.g., also 16 bits) may be used to represent a path, obviating the need to include multiple node RNTIs in the PDCCH payload.

By way of example, in FIG. 5B, rather than including RNTIs for each relay along the path from the base station, to relay 1, to relay 2, and to UE 1, one of four link IDs may be selected (e.g., by the base station) to be included in the payload of the PDCCH. For example, one link ID may represent the path from the base station to relay 1, another link ID may represent the path from the base station to relay 3, another link ID may represent the path from the base station to relay 2 through relay 1, and another link ID may represent the path from the base station to relay 3 through relay 1.

As shown by reference number 530, the node (e.g., relay 1) may transmit the second control channel (e.g., the second PDCCH) with an identifier of a next node on the path (e.g., relay 2) based at least in part on the link identifier. For example, the link ID for example 520 may identify the path as going from the base station to relay 1 and then to relay 2.

As indicated above, FIG. 5B is provided as an example. Other examples may differ from what is described with regard to FIG. 5B.

FIG. 5C is a diagram illustrating an example 535 associated with control channel based routing for multiple relay based communication, in accordance with the present disclosure. As shown in FIG. 5C, a base station (e.g., base station 110) and multiple nodes (e.g., relay stations 110d) may communicate with one another and with one or more UEs (e.g., UE 120). Example 535 shown in FIG. 5C may be similar to example 520 of FIG. 5B; therefore, the description of FIG. 5C focuses on differences between examples 520 and 535.

As shown by reference number 540, in some aspects, the information included in the payload (e.g., of the first PDCCH) includes a link ID of a path between a source of the payload and a UE, or other node, that is the destination of the payload. For example, a link ID may be included in the payload, rather than separate node identifiers for each of the nodes along a path from the base station to the destination UE or node and a UE or node identifier. The link ID identifies the route from the base station to the destination UE or node. Including the link ID may reduce a load of the first control channel relative to including multiple node identifiers and the UE ID or node ID. For example, RNTIs (e.g., used as node IDs and UE ID) may take 16 bits each to represent, and a single link ID (e.g., also 16 bits) may be used to represent a path, obviating the need to include multiple node RNTIs and the UE RNTI in the PDCCH payload.

By way of example, in FIG. 5C, rather than including RNTIs for each relay and destination node or UE along the path from the base station, to relay 1, to relay 2, and to UE 1, a link ID may be selected (e.g., by the base station) to be included in the payload of the PDCCH. For example, one link ID may be used to represent the path from the base station through relay 1, relay 2, and UE 1.

As shown by reference number 545, the node (e.g., relay 1) may transmit the second control channel (e.g., the second PDCCH) with an identifier of a next node on the path (e.g., relay 2) based at least in part on the link ID. For example, the link ID for example 535 may identify the path as going from the base station to relay 1, then to relay 2, and then to UE 1.

As indicated above, FIG. 5C is provided as an example. Other examples may differ from what is described with regard to FIG. 5C.

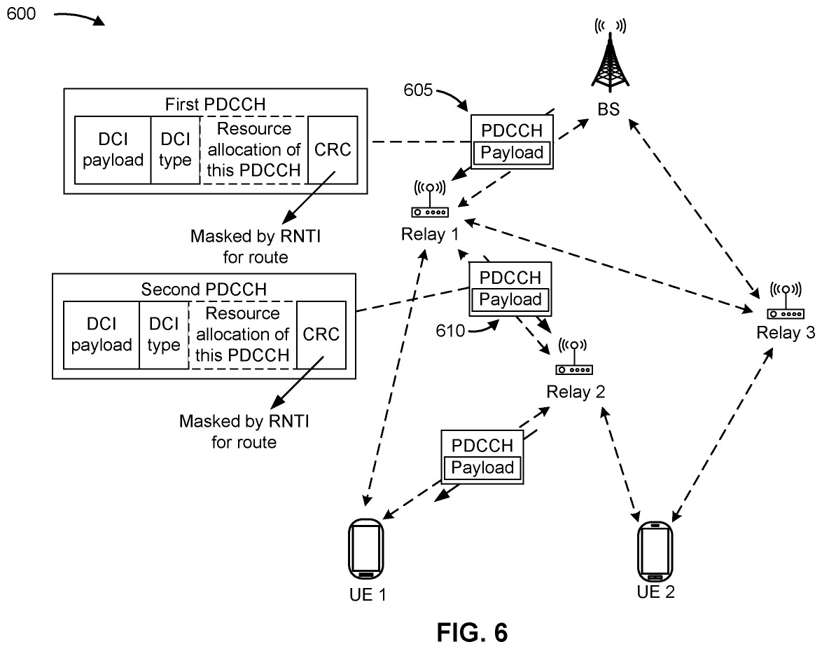

FIG. 6 is a diagram illustrating an example 600 associated with control channel based routing for multiple relay based communication, in accordance with the present disclosure. As shown in FIG. 6, a base station (e.g., base station 110) and multiple nodes (e.g., relay stations 110d) may communicate with one another and with one or more UEs (e.g., UE 120). Some parts of example 600 are similar to example 500 of FIG. 5A. Therefore, the description of FIG. 6 focuses on some differences between examples 500 and 600 (though examples 500 and 600 may differ from each other in ways not explicitly described here).

In some aspects, each node may be configured (e.g., by the base station) with a mapping between an identifier associated with a first control channel (e.g., first PDCCH) and a child node of the node (or the node itself). In some aspects, the mapping indicates an identifier for a second control channel (e.g., second PDCCH) associated with routing the payload to the target node. For example, in a situation where an identifier (e.g., RNTI) is used to indicate routing information for a PDCCH, the base station may configure each node (e.g., via the configuration information) with a mapping from an RNTI of an incoming PDCCH to the child node, and the RNTI to be used for the outgoing PDCCH. In some aspects, the identifier for the control channel corresponds to a plurality of nodes, including a child node of the node, on a path to the target node. For example, an RNTI may correspond to multiple nodes, indicating a route to the target node and/or the destination UE.

As shown by reference number 605, the base station transmits a first PDCCH to relay 1. The routing information may be indicated by an RNTI used to mask the cyclic redundancy check (CRC) of the first PDCCH, and by a mapping for relay 1.

By way of example, in FIG. 6, the mapping for relay 1 may include routing information for eleven RNTIs: a self RNTI (e.g., RIC-RNTI) and five pairs: a pair for relay 2 (e.g., R12-RNTI for incoming PDCCH, R2C-RNTI for outgoing PDCCH), a pair for UE 1 through relay 2 (e.g., R121-RNTI for incoming PDCCH, R21C-RNTI for outgoing PDCCH), a pair for UE 2 through relay 2 (e.g., R122-RNTI for incoming PDCCH, R22C-RNTI for outgoing PDCCH), a pair for relay 3 (e.g., R13-RNTI for incoming PDCCH, R3C-RNTI for outgoing PDCCH), a pair for UE 2 though relay 3 (e.g., R132-RNTI for incoming PDCCH, R32C-RNTI for outgoing PDCCH). In this example, relay 2 and relay 3 may each have five RNTIs configured via the configuration information, UE 1 may have one RNTI configured via the configuration information, and UE 2 may have 3 RNTIs configured via the configuration information.

In some aspects, the identifier associated with the first control channel is associated with each node on a path between the source of the payload and the target node or target UE. For example, in some aspects, all nodes on a route may share the same RNTI for that route. In some aspects, the RNTI for the route may include the destination UE. By way of example, in FIG. 6, the mapping for relay 1 may include routing information for six RNTIs for relay 1: a first RNTI for the route from the base station to relay 1; a second RNTI for the route from the base station to relay 1, to relay 2; a third RNTI for the route from the base station to relay 1, to relay 2, and to UE 1; a fourth RNTI for the route from the base station to relay 1, to relay 2, and to UE 2; a fifth RNTI for the route from the base station to relay 1, to relay 3; and a sixth RNTI for the route from the base station to relay 1, to relay 3, to UE 2. In this example, three RNTIs may be configured for relay 2, four for relay 3, one for UE 1, and three for UE 2.

As shown by reference number 610, the second PDCCH may be transmitted to a child node of the node on a path to the target node based at least in part on the mapping between the RNTI indicated by the first PDCCH and the child node (e.g., relay 2). For example, relay 1 may use the route RNTI and a previously configured mapping to determine to route the communication to relay 2.

In some aspects, the node may transmit the second control channel using a differentiation technique, such that a recipient node can determine whether the second control channel is destined for the recipient node. For example, in a situation where all nodes on a route share the same RNTI, nodes receiving a PDCCH may use a differentiation technique (e.g., using a different search space, TDM, and/or FDM, among other examples) to enable the node to determine if the PDCCH is destined for that node or is to be forwarded in accordance with the mapping.

As indicated above, FIG. 6 is provided as an example. Other examples may differ from what is described with regard to FIG. 6.

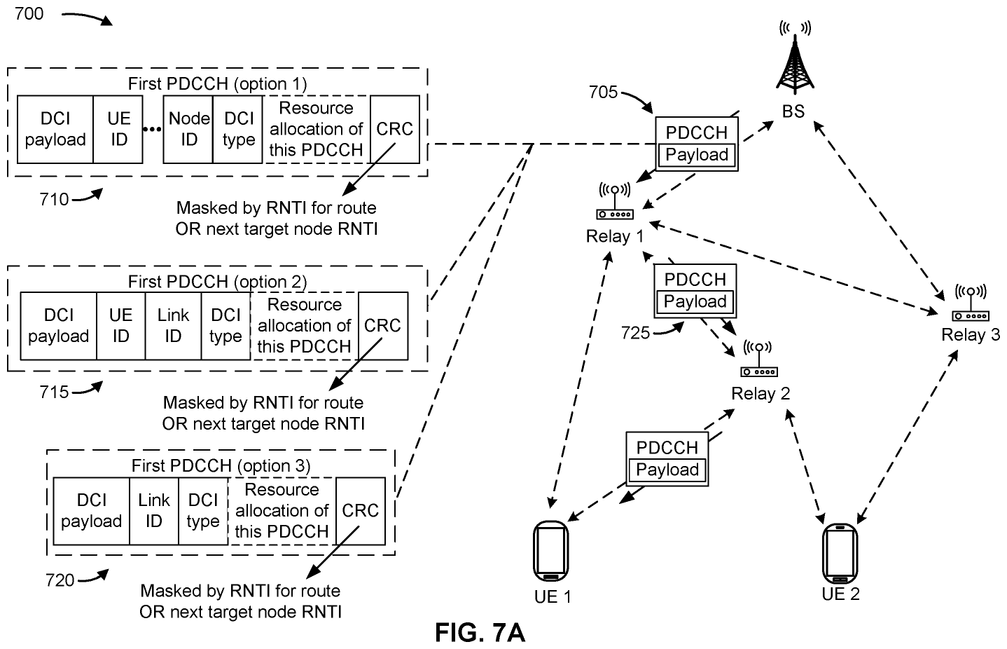

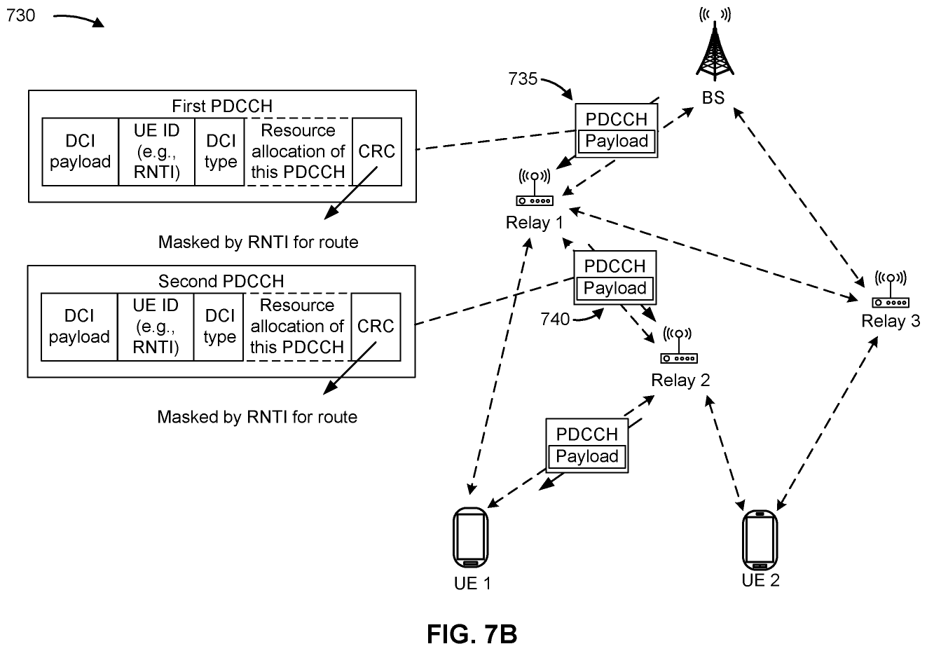

As indicated above, FIG. 7A is provided as an example. Other examples may differ from what is described with regard to FIG. 7A. As shown in FIG. 7A, a base station (e.g., base station 110) and multiple nodes (e.g., relay stations 110d) may communicate with one another and with one or more UEs (e.g., UE 120). Some parts of example 700 shown in FIG. 7A may be similar to one or more of examples 500, 520, 535, and 600 of FIGS. 5A, 5B, 5C, and 6, respectively. Therefore, the description of FIG. 7A describes differences between examples 500, 520, 535, 600, and 700 (though other differences may arise that are not explicitly described).

In some aspects, one or more of the nodes are to be configured for a first type of routing, and one or more other nodes are to be configured for a second type of routing. In some aspects, the identifier for a control channel may correspond to multiple nodes, including a child node of the node, on a path to a target node, and the identifier for the control channel may be the same, irrespective of an upstream route of the control channel. For example, some nodes may be configured with a mapping of identifiers (e.g., RNTIs) of an incoming PDCCH to a next node ID and the identifier (e.g., RNTI) to be used for an outgoing PDCCH. The nodes not configured in the foregoing manner may be configured using a shared identifier (e.g., a shared RNTI), such that an incoming PDCCH from different routes would share the same identifier. In some aspects, one or more identifiers (e.g., node IDs, link IDs, and/or destination UE IDs) may be included in the PDCCH payload.

As shown by reference number 705, FIG. 7 provides three example options for the first PDCCH transmitted from the base station to relay 1. The first option, as shown by reference number 710, may be considered a combination of parts of example 500 described with respect to FIG. 5A and example 600 described with respect to FIG. 6. For example, the first PDCCH payload includes a UE ID (e.g., UE RNTI) for a destination UE (e.g., UE 1), and one or more node IDs (e.g., node RNTIs) to which the PDCCH is to be routed. The first PDCCH also includes a CRC masked by either an RNTI for a route or the next target node's RNTI. For example, the CRC may be masked by an RNTI for relay 2 or an RNTI for a route from the base station through relay 1 and relay 2. A mapping for relay 1 indicates the RNTI to be used for the second (e.g., outgoing) PDCCH, and in some aspects, the other relays (e.g., relay 2) may be configured with a shared RNTI.

The second option, as shown by reference number 715, may be considered a combination of parts of example 520 described with respect to FIG. 5B and example 600 described with respect to FIG. 6. For example, the first PDCCH payload includes a UE ID (e.g., UE RNTI) for a destination UE (e.g., UE 1) and a link ID indicating a route to the last relay (e.g., relay 2) to which the PDCCH is to be routed. The first PDCCH also includes a CRC masked by either an RNTI for a route or the next target node's RNTI. For example, the CRC may be masked by an RNTI for relay 2 or an RNTI for a route from the base station through relay 1 and relay 2.

The third option, as shown by reference number 720, may be considered a combination of example 535 described with respect to FIG. 5C and example 600 described with respect to FIG. 6. For example, the first PDCCH payload includes a link ID indicating a route to the destination UE (e.g., UE 1) to which the PDCCH is to be routed. The first PDCCH also includes a CRC masked by either an RNTI for a route or the next target node's RNTI. For example, the CRC may be masked by an RNTI for relay 2 or an RNTI for a route from the base station through relay 1 and relay 2.

As shown by reference number 725, in some aspects, when relay 1 routes the second PDCCH to relay 2, the payload may stay the same, though the CRC may be masked by the RNTI for relay 2, enabling relay 2 to decode the second PDCCH and determine the destination UE based at least in part on the payload of the second PDCCH (e.g., as in the second PDCCH of any of FIGS. 5A-5C).

In some aspects, a node which directly connects with another type of node may have three types of RNTI: an RNTI for itself, an RNTI for the other type of node (e.g., child node RNTI), and different RNTIs to target different relays (e.g., route RNTIs). In this way, the number of RNTIs needed may be reduced in various circumstances.

FIG. 7B is a diagram illustrating an example 730 associated with control channel based routing for multiple relay based communication, in accordance with the present disclosure. As shown in FIG. 7B, a base station (e.g., base station 110) and multiple nodes (e.g., relay stations 110d) may communicate with one another and with one or more UEs (e.g., UE 120). Example 730 shown in FIG. 7B may be similar to example 700 of FIG. 7A; therefore, the description of FIG. 7B describes some differences between examples 700 and 730.

In some aspects, a route RNTI (e.g., as described above with reference to FIG. 6) may be combined with a UE identifier included in a payload of a control channel (e.g., as described above with reference to FIGS. 5A and 5B). For example, a base station may configure a route to reach each target node (e.g., a target node being the last node prior to a UE for downlink communication), and each node of the route may share the same identifier (e.g., a route RNTI). In this way, a shared route RNTI may be used to route a PDCCH to a target node, and the target node may use the UE ID of the payload to route the PDCCH to the destination UE.

As shown by reference number 735, the first PDCCH is similar to example 520 described with respect to FIG. 5B and example 600 described with respect to FIG. 6. For example, the first PDCCH payload includes a UE ID (e.g., UE RNTI) for a destination UE (e.g., UE 1), but no node IDs or link IDs are included in the payload. The CRC of the first PDCCH is masked by an RNTI for a route. For example, the CRC may be masked by an RNTI for a route from the base station through relay 1 and to relay 2.

As shown by reference number 740, the second PDCCH includes the same data included in the first PDCCH (e.g., the UE ID in the payload of the second PDCCH) and the route RNTI masking the CRC. In this situation, relay 2 may use a differentiation technique (e.g., different search space, TDM, and/or FDM, among other examples) to determine whether the second PDCCH is for relay 2. After determining that the second PDCCH is for relay 2, relay 2 may extract the UE ID from the payload of the second PDCCH and the payload may then be transmitted to the destination UE (e.g., UE 1).

In this situation, three RNTIs may be configured for relay 1: an RNTI for itself, a second RNTI for the route traversing relay 1 and relay 2, and a third RNTI for the route traversing relay 1 and relay 3. In this example, relay 2 may use two RNTIs (e.g., an RNTI for itself and another RNTI for the route traversing relay 1 to relay 2), relay 3 may use 3 RNTIs (e.g., an RNTI for itself, another RNTI for the route traversing relay 1 to relay 3, and another RNTI for itself as the target node before the destination UE).

As indicated above, FIG. 7B is provided as an example. Other examples may differ from what is described with regard to FIG. 7B.

While the foregoing examples are presented in the context of downlink communications via multiple relays, the same techniques may be applied for uplink and/or sidelink communications via multiple relays.

In this way, some techniques and apparatuses described herein enable the use of multiple relays for communications between a base station and UE. This may improve network performance and increase reliability by providing link diversity for communications between a UE and base station. In addition, the use of multiple relays may be used to increase an effective range and/or coverage of the base station, while also reducing the load of the base station. The use of control channel based routing may also conserve resources of the base station, including processing resources, time resources, memory resources, and/or power resources, among other examples, which may include resources that would otherwise be consumed by the base station to track the status of decoding at multiple node and/or schedule a node's downlink and uplink communications.

FIG. 8 is a diagram illustrating an example process 800 performed, for example, by a node, in accordance with the present disclosure. Example process 800 is an example where the node (e.g., relay station 110d, UE 120, BS 110) performs operations associated with control channel based routing for multiple relay based communication.

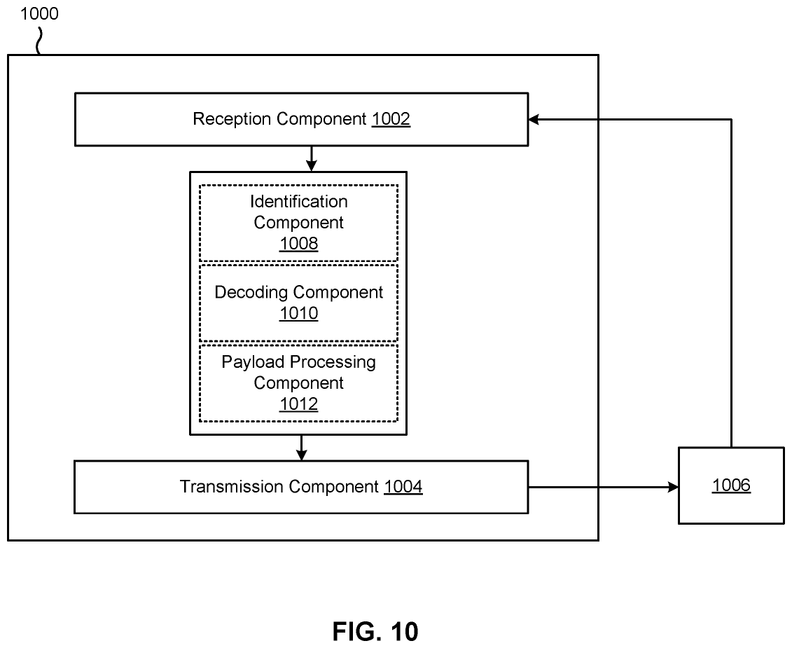

As shown in FIG. 8, in some aspects, process 800 may include receiving a first control channel associated with a multiple relay based communication (block 810). For example, the node (e.g., using reception component 1002, depicted in FIG. 10) may receive a first control channel associated with a multiple relay based communication, as described above.

As further shown in FIG. 8, in some aspects, process 800 may include identifying a target node of a payload of the first control channel based at least in part on at least one of: information included in the payload, or an identifier associated with the first control channel (block 820). For example, the node (e.g., using identification component 1008, depicted in FIG. 10) may identify a target node of a payload of the first control channel based at least in part on at least one of: information included in the payload, or an identifier associated with the first control channel, as described above.

As further shown in FIG. 8, in some aspects, process 800 may include transmitting a second control channel carrying the payload toward the target node if the node is not the target node (block 830). For example, the node (e.g., using transmission component 1004, depicted in FIG. 10) may transmit a second control channel carrying the payload toward the target node if the node is not the target node, as described above.

As further shown in FIG. 8, in some aspects, process 800 may include decoding the payload, if the node is the target node (block 840). For example, the node (e.g., using decoding component 1010, depicted in FIG. 10) may decode the payload, if the node is the target node, as described above.

Process 800 may include additional aspects, such as any single aspect or any combination of aspects described below and/or in connection with one or more other processes described elsewhere herein.

In a first aspect, process 800 includes receiving a grant for a resource associated with the second control channel, wherein the second control channel is transmitted on the resource of the grant.

In a second aspect, the grant is one of a dynamic grant, or a configured grant.

In a third aspect, process 800 includes receiving information indicating a downlink control information (DCI) type of the first control channel, wherein receiving the first control channel is based at least in part on the DCI type.

In a fourth aspect, the information included in the payload is a node identifier of one or more nodes on a path between a source of the payload and the target node.

In a fifth aspect, the node identifier is configured as associated with the path or the one or more nodes.

In a sixth aspect, process 800 includes removing a destination field that includes the node identifier from the payload for transmission via the second control channel, and adding, to the payload, an updated node identifier for transmission via the second control channel.

In a seventh aspect, process 800 includes removing the node identifier from the payload for transmission via the second control channel, padding the payload to satisfy a downlink control information length threshold, and adding, to the payload, an updated node identifier for transmission via the second control channel.

In an eighth aspect, the information included in the payload includes a UE identifier of a UE associated with the payload and a link identifier of a path between a source of the payload and the target node.

In a ninth aspect, transmitting the second control channel further comprises transmitting the second control channel with an identifier of a next node on the path based at least in part on the link identifier.

In a tenth aspect, the information included in the payload is a link identifier of a path between a source of the payload and a user equipment that is a destination of the payload.

In an eleventh aspect, the identifier associated with the first control channel is a radio network temporary identifier.

In a twelfth aspect, transmitting the second control channel toward the target node further comprises transmitting the second control channel to a child node of the node on a path to the target node based at least in part on a mapping between the identifier associated with the first control channel and the child node.

In a thirteenth aspect, the mapping indicates an identifier for the second control channel associated with routing the payload to the target node.

In a fourteenth aspect, the identifier for the second control channel corresponds to a plurality of nodes, including the child node, on the path to the target node, and the identifier for the second control channel is the same irrespective of an upstream route of the second control channel.

In a fifteenth aspect, transmitting the second control channel to a child node on a path to the target node is based at least in part on an identifier of the child node or an identifier of the path associated with the first control channel.

In a sixteenth aspect, the identifier associated with the first control channel is associated with each node of a plurality of nodes on a path between a source of the payload and the target node.

In a seventeenth aspect, transmitting the second control channel further comprises transmitting the second control channel using a differentiation technique such that a recipient node of the plurality of nodes can determine whether the second control channel is destined for the recipient node.

In an eighteenth aspect, the identifier associated with the first control channel is associated with a UE for which the payload is destined.

In a nineteenth aspect, the target node is a last node on the path before a UE and the payload includes an identifier of the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with control channel based routing for multiple relay based communication.

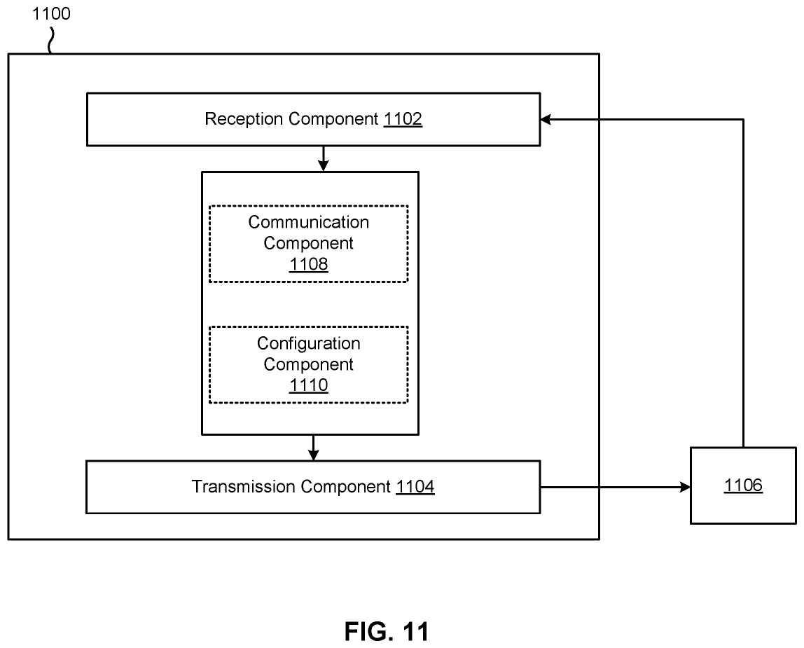

As shown in FIG. 9, in some aspects, process 900 may include generating a multiple relay based communication including a first control channel with a payload destined for a UE (block 910). For example, the base station (e.g., using communication component 1108, depicted in FIG. 11) may generate a multiple relay based communication including a first control channel with a payload destined for a UE, as described above.

As further shown in FIG. 9, in some aspects, process 900 may include transmitting, to a node, the first control channel, wherein the first control channel indicates a target node of a payload of the first control channel based at least in part on at least one of: information included in the payload, or an identifier associated with the first control channel (block 920). For example, the base station (e.g., using transmission component 1104, depicted in FIG. 11) may transmit, to a node, the first control channel, wherein the first control channel indicates a target node of a payload of the first control channel based at least in part on at least one of: information included in the payload, or an identifier associated with the first control channel, as described above.

Process 900 may include additional aspects, such as any single aspect or any combination of aspects described below and/or in connection with one or more other processes described elsewhere herein.

In a first aspect, process 900 includes transmitting a grant for a resource associated with a second control channel via which the payload is to be transmitted to a child node of the node.

In a second aspect, the grant is one of a dynamic grant, or a configured grant.

In a third aspect, process 900 includes transmitting information indicating a DCI type of the first control channel.

In a fourth aspect, the information included in the payload is a node identifier of one or more nodes on a path between a source of the payload and the target node.

In a fifth aspect, the node identifier is configured as associated with the path or the one or more nodes.

In a sixth aspect, the information included in the payload is a UE identifier of the UE or a link identifier of a path between a source of the payload and the target node.

In a seventh aspect, the information included in the payload is a link identifier of a path between a source of the payload and the UE.

In an eighth aspect, the identifier associated with the first control channel is a radio network temporary identifier.

In a ninth aspect, process 900 includes configuring, for the node, a mapping between the identifier associated with the first control channel and a child node of the node.

In a tenth aspect, the mapping indicates an identifier for a control channel associated with routing the payload to the target node.

In an eleventh aspect, the identifier for the control channel corresponds to a plurality of nodes, including a child node of the node, on a path to the target node, and the identifier for the control channel is the same irrespective of an upstream route of the control channel.

In a twelfth aspect, routing of the payload on a path to the target node is based at least in part on an identifier of the child node or an identifier of the path associated with the first control channel.

In a thirteenth aspect, the identifier associated with the first control channel is associated with each node of a plurality of nodes on a path between the base station and the target node.

In a fourteenth aspect, the identifier associated with the first control channel is associated with the UE to which the payload is destined.

In a fifteenth aspect, the target node is a last node on the path before the UE and the payload includes an identifier of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a node, or a node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of an identification component 1008, a decoding component 1010, or a payload processing component 1012, among other examples.

In some aspects, the apparatus 1000 may be configured to perform one or more operations described herein in connection with FIGS. 4-7B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the node described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the node described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the node described above in connection with FIG. 2. In some aspects, the transmission component 1004 may be co-located with the reception component 1002 in a transceiver.

The reception component 1002 may receive a first control channel associated with a multiple relay based communication. The identification component 1008 may identify a target node of a payload of the first control channel based at least in part on at least one of information included in the payload, or an identifier associated with the first control channel. The transmission component 1004 may transmit a second control channel carrying the payload toward the target node if the node is not the target node. The decoding component 1010 may decode the payload, if the node is the target node.

The reception component 1002 may receive a grant for a resource associated with the second control channel, wherein the second control channel is transmitted on the resource of the grant.

The reception component 1002 may receive information indicating a DCI type of the first control channel, wherein receiving the first control channel is based at least in part on the DCI type.

The payload processing component 1012 may remove a destination field that includes the node identifier from the payload for transmission via the second control channel.

The payload processing component 1012 may add, to the payload, an updated node identifier for transmission via the second control channel.

The payload processing component 1012 may remove the node identifier from the payload for transmission via the second control channel.

The payload processing component 1012 may pad the payload to satisfy a downlink control information length threshold.

The payload processing component 1012 may add, to the payload, an updated node identifier for transmission via the second control channel.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include one or more of a communication component 1108 or a configuration component 1110, among other examples.

In some aspects, the apparatus 1100 may be configured to perform one or more operations described herein in connection with FIGS. 4-7B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The communication component 1108 may generate a multiple relay based communication including a first control channel with a payload destined for a UE. The transmission component 1104 may transmit, to a node, the first control channel, wherein the first control channel indicates a target node of a payload of the first control channel based at least in part on at least one of information included in the payload, or an identifier associated with the first control channel.

The transmission component 1104 may transmit a grant for a resource associated with a second control channel via which the payload is to be transmitted to a child node of the node.

The transmission component 1104 may transmit information indicating a downlink control information type of the first control channel.

The configuration component 1110 may configure, for the node, a mapping between the identifier associated with the first control channel and a child node of the node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a node, comprising: receiving a first control channel associated with a multiple relay based communication; identifying a target node of a payload of the first control channel based at least in part on at least one of: information included in the payload, or an identifier associated with the first control channel; and transmitting a second control channel carrying the payload toward the target node if the node is not the target node; or decoding the payload, if the node is the target node.

Aspect 2: The method of Aspect 1, further comprising: receiving a grant for a resource associated with the second control channel, wherein the second control channel is transmitted on the resource of the grant.

Aspect 3: The method of Aspect 2, wherein the grant is one of: a dynamic grant, or a configured grant.

Aspect 4: The method of any of Aspects 1-3, further comprising: receiving information indicating a downlink control information (DCI) type of the first control channel, wherein receiving the first control channel is based at least in part on the DCI type.

Aspect 5: The method of any of Aspects 1-4, wherein the information included in the payload is a node identifier of one or more nodes on a path between a source of the payload and the target node.

Aspect 6: The method of Aspect 5, wherein the node identifier is configured as associated with the path or the one or more nodes.

Aspect 7: The method of Aspect 5, further comprising: removing a destination field that includes the node identifier from the payload for transmission via the second control channel; and adding, to the payload, an updated node identifier for transmission via the second control channel.

Aspect 8: The method of Aspect 5, further comprising: removing the node identifier from the payload for transmission via the second control channel; padding the payload to satisfy a downlink control information length threshold; and adding, to the payload, an updated node identifier for transmission via the second control channel.

Aspect 9: The method of any of Aspects 1-4, wherein the information included in the payload includes a user equipment (UE) identifier of a UE associated with the payload and a link identifier of a path between a source of the payload and the target node.

Aspect 10: The method of Aspect 9, wherein transmitting the second control channel further comprises: transmitting the second control channel with an identifier of a next node on the path based at least in part on the link identifier.

Aspect 11: The method of any of Aspects 1-10, wherein the information included in the payload is a link identifier of a path between a source of the payload and a user equipment that is a destination of the payload.

Aspect 12: The method of any of Aspects 1-11, wherein the identifier associated with the first control channel is a radio network temporary identifier.

Aspect 13: The method of Aspect 12, wherein transmitting the second control channel toward the target node further comprises: transmitting the second control channel to a child node of the node on a path to the target node based at least in part on a mapping between the identifier associated with the first control channel and the child node.

Aspect 14: The method of Aspect 13, wherein the mapping indicates an identifier for the second control channel associated with routing the payload to the target node.

Aspect 15: The method of Aspect 14, wherein the identifier for the second control channel corresponds to a plurality of nodes, including the child node, on the path to the target node, and wherein the identifier for the second control channel is the same irrespective of an upstream route of the second control channel.

Aspect 16: The method of Aspect 14, wherein transmitting the second control channel to a child node on a path to the target node is based at least in part on an identifier of the child node or an identifier of the path associated with the first control channel.

Aspect 17: The method of any of Aspects 1-16, wherein the identifier associated with the first control channel is associated with each node of a plurality of nodes on a path between a source of the payload and the target node.

Aspect 18: The method of Aspect 17, wherein transmitting the second control channel further comprises: transmitting the second control channel using a differentiation technique such that a recipient node of the plurality of nodes can determine whether the second control channel is destined for the recipient node.

Aspect 19: The method of Aspect 17, wherein the identifier associated with the first control channel is associated with a user equipment for which the payload is destined.

Aspect 20: The method of Aspect 17, wherein the target node is a last node on the path before a user equipment and wherein the payload includes an identifier of the user equipment.

Aspect 21: A method of wireless communication performed by a base station, comprising: generating a multiple relay based communication including a first control channel with a payload destined for a user equipment (UE); and transmitting, to a node, the first control channel, wherein the first control channel indicates a target node of a payload of the first control channel based at least in part on at least one of: information included in the payload, or an identifier associated with the first control channel.

Aspect 22: The method of Aspect 21, further comprising: transmitting a grant for a resource associated with a second control channel via which the payload is to be transmitted to a child node of the node.

Aspect 23: The method of Aspect 22, wherein the grant is one of: a dynamic grant, or a configured grant.

Aspect 24: The method of any of Aspects 21-23, further comprising: transmitting information indicating a downlink control information type of the first control channel.

Aspect 25: The method of any of Aspects 21-24, wherein the information included in the payload is a node identifier of one or more nodes on a path between a source of the payload and the target node.

Aspect 26: The method of Aspect 25, wherein the node identifier is configured as associated with the path or the one or more nodes.

Aspect 27: The method of any of Aspects 21-24, wherein the information included in the payload is a UE identifier of the UE or a link identifier of a path between a source of the payload and the target node.

Aspect 28: The method of any of Aspects 21-24, wherein the information included in the payload is a link identifier of a path between a source of the payload and the UE.

Aspect 29: The method of any of Aspects 21-28, wherein the identifier associated with the first control channel is a radio network temporary identifier.

Aspect 30: The method of any of Aspects 21-29, further comprising: configuring, for the node, a mapping between the identifier associated with the first control channel and a child node of the node.

Aspect 31: The method of Aspect 30, wherein the mapping indicates an identifier for a control channel associated with routing the payload to the target node.

Aspect 32: The method of Aspect 31, wherein the identifier for the control channel corresponds to a plurality of nodes, including a child node of the node, on a path to the target node, and wherein the identifier for the control channel is the same irrespective of an upstream route of the control channel.

Aspect 33: The method of Aspect 31, wherein routing of the payload on a path to the target node is based at least in part on an identifier of the child node or an identifier of the path associated with the first control channel.

Aspect 34: The method of any of Aspects 21-32, wherein the identifier associated with the first control channel is associated with each node of a plurality of nodes on a path between the base station and the target node.

Aspect 35: The method of Aspect 34, wherein the identifier associated with the first control channel is associated with the UE to which the payload is destined.

Aspect 36: The method of Aspect 34, wherein the target node is a last node on the path before the UE and wherein the payload includes an identifier of the UE.

Aspect 37: An apparatus for wireless communication at a device, comprising a processor; memory coupled with the processor; and instructions stored in the memory and executable by the processor to cause the apparatus to perform the method of one or more Aspects of Aspects 1-20.

Aspect 38: An apparatus for wireless communication at a device, comprising a processor; memory coupled with the processor; and instructions stored in the memory and executable by the processor to cause the apparatus to perform the method of one or more Aspects of Aspects 21-36.

Aspect 39: A device for wireless communication, comprising a memory and one or more processors coupled to the memory, the memory and the one or more processors configured to perform the method of one or more Aspects of Aspects 1-20.

Aspect 40: A device for wireless communication, comprising a memory and one or more processors coupled to the memory, the memory and the one or more processors configured to perform the method of one or more Aspects of Aspects 21-36.

Aspect 41: An apparatus for wireless communication, comprising at least one means for performing the method of one or more Aspects of Aspects 1-20.

Aspect 42: An apparatus for wireless communication, comprising at least one means for performing the method of one or more Aspects of Aspects 21-36.

Aspect 43: A non-transitory computer-readable medium storing code for wireless communication, the code comprising instructions executable by a processor to perform the method of one or more Aspects of Aspects 1-20.

Aspect 44: A non-transitory computer-readable medium storing code for wireless communication, the code comprising instructions executable by a processor to perform the method of one or more Aspects of Aspects 21-36.

Aspect 45: A non-transitory computer-readable medium storing a set of instructions for wireless communication, the set of instructions comprising one or more instructions that, when executed by one or more processors of a device, cause the device to perform the method of one or more Aspects of Aspects 1-20.

Aspect 46: A non-transitory computer-readable medium storing a set of instructions for wireless communication, the set of instructions comprising one or more instructions that, when executed by one or more processors of a device, cause the device to perform the method of one or more Aspects of Aspects 21-36.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having.” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a node, comprising:
receiving a first control channel associated with a multiple relay based communication;
identifying a target node of a payload of the first control channel based at least in part on at least one of:
information included in the payload, or
an identifier associated with the first control channel; and
transmitting a second control channel carrying the payload toward the target node if the node is not the target node; or
decoding the payload, if the node is the target node.

2. The method of claim 1, further comprising:
receiving a grant for a resource associated with the second control channel, wherein the second control channel is transmitted on the resource of the grant.

3. The method of claim 2, wherein the grant is one of:
a dynamic grant, or
a configured grant.

4. The method of claim 1, further comprising:
receiving information indicating a downlink control information (DCI) type of the first control channel, wherein receiving the first control channel is based at least in part on the DCI type.

5. The method of claim 1, wherein the information included in the payload is a node identifier of one or more nodes on a path between a source of the payload and the target node.

6. The method of claim 5, wherein the node identifier is configured as associated with the path or the one or more nodes.

7. The method of claim 5, further comprising:
removing a destination field that includes the node identifier from the payload for transmission via the second control channel; and
adding, to the payload, an updated node identifier for transmission via the second control channel.

8. The method of claim 5, further comprising:
removing the node identifier from the payload for transmission via the second control channel;
padding the payload to satisfy a downlink control information length threshold; and
adding, to the payload, an updated node identifier for transmission via the second control channel.

9. The method of claim 1, wherein the information included in the payload includes a user equipment (UE) identifier of a UE associated with the payload and a link identifier of a path between a source of the payload and the target node.

10. The method of claim 9, wherein transmitting the second control channel further comprises:
transmitting the second control channel with an identifier of a next node on the path based at least in part on the link identifier.

11. The method of claim 1, wherein the information included in the payload is a link identifier of a path between a source of the payload and a user equipment that is a destination of the payload.

12. The method of claim 1, wherein the identifier associated with the first control channel is a radio network temporary identifier.

13. The method of claim 12, wherein transmitting the second control channel toward the target node further comprises:
transmitting the second control channel to a child node of the node on a path to the target node based at least in part on a mapping between the identifier associated with the first control channel and the child node.

14. The method of claim 13, wherein the mapping indicates an identifier for the second control channel associated with routing the payload to the target node.

15. The method of claim 14, wherein the identifier for the second control channel corresponds to a plurality of nodes, including the child node, on the path to the target node, and wherein the identifier for the second control channel is the same irrespective of an upstream route of the second control channel.

16. The method of claim 14, wherein transmitting the second control channel to a child node on a path to the target node is based at least in part on an identifier of the child node or an identifier of the path associated with the first control channel.

17. The method of claim 1, wherein the identifier associated with the first control channel is associated with each node of a plurality of nodes on a path between a source of the payload and the target node.

18. The method of claim 17, wherein transmitting the second control channel further comprises:
transmitting the second control channel using a differentiation technique such that a recipient node of the plurality of nodes can determine whether the second control channel is destined for the recipient node.

19. The method of claim 17, wherein the identifier associated with the first control channel is associated with a user equipment for which the payload is destined.

20. The method of claim 17, wherein the target node is a last node on the path before a user equipment and wherein the payload includes an identifier of the user equipment.

21. A method of wireless communication performed by a base station, comprising:
generating a multiple relay based communication including a first control channel with a payload destined for a user equipment (UE); and
transmitting, to a node, the first control channel, wherein the first control channel indicates a target node of a payload of the first control channel based at least in part on at least one of:
information included in the payload, or
an identifier associated with the first control channel.

22. The method of claim 21, further comprising:
transmitting a grant for a resource associated with a second control channel via which the payload is to be transmitted to a child node of the node.

23. The method of claim 21, further comprising:
transmitting information indicating a downlink control information type of the first control channel.

24. The method of claim 21, further comprising:
configuring, for the node, a mapping between the identifier associated with the first control channel and a child node of the node.

25. The method of claim 21, wherein the identifier associated with the first control channel is associated with each node of a plurality of nodes on a path between the base station and the target node.

26. A node, comprising:
one or more memories; and
one or more processors, coupled to the one or more memories, configured to:
receive a first control channel associated with a multiple relay based communication;
identify a target node of a payload of the first control channel based at least in part on at least one of:
information included in the payload, or
an identifier associated with the first control channel; and
transmit a second control channel carrying the payload toward the target node if the node is not the target node; or
decode the payload, if the node is the target node.

27. The node of claim 26, wherein the one or more processors are further configured to:
receive a grant for a resource associated with the second control channel, wherein the second control channel is transmitted on the resource of the grant.

28. The node of claim 26, wherein the one or more processors are further configured to:
receive information indicating a downlink control information (DCI) type of the first control channel, wherein receiving the first control channel is based at least in part on the DCI type.

29. A base station, comprising:
one or more memories; and
one or more processors, coupled to the one or more memories, configured to:
generate a multiple relay based communication including a first control channel with a payload destined for a user equipment (UE); and
transmit, to a node, the first control channel, wherein the first control channel indicates a target node of a payload of the first control channel based at least in part on at least one of:
information included in the payload, or
an identifier associated with the first control channel.

30. The base station of claim 29, wherein the one or more processors are further configured to:
transmit a grant for a resource associated with a second control channel via which the payload is to be transmitted to a child node of the node.
